(19) United States
(12) Patent Application Publication
(10) Pub. No.: US 2024/0267842 A1
(43) Pub. Date: Aug. 8, 2024

(54) WIRELESS APPARATUS AND METHOD FOR MOBILE NETWORK POWER SAVING

(71) Applicant: Huawei Technologies Co., Ltd., Shenzhen (CN)

(72) Inventors: Yongxia Lyu, Kanata (CA); Dongdong Wei, Kanata (CA); Jianglei Ma, Ottawa (CA); Ting Wang, Kanata (CA)

(21) Appl. No.: 18/642,085

(22) Filed: Apr. 22, 2024

Related U.S. Application Data
(63) Continuation of application No. PCT/CN2021/125474, filed on Oct. 22, 2021.

(51) Int. Cl. H04W 52/02; H04W 68/02; H04W 76/20; H04W 84/04

(52) U.S. Cl. CPC H04W 52/0206; H04W 68/02; H04W 76/20; H04W 84/042

(57) ABSTRACT

A dynamic mobile network architecture is provided, with the objective of meeting greenhouse gas emission targets. The network adapts over time based on time varied traffic demand/load. This is achieved by providing two layers of base stations (BS). The top layer contains super BS that have larger coverage areas than the base stations of the second layer. Depending on traffic conditions, base stations of the second layer can be switched into a reduced power mode. Signalling procedures are provided for setting up connections between the BS of the second layer and the super BS, and for switching off and then activating previously switched off second layer BS. In some cases, the BS of the second layer has a lower power listening receiver to allow itself to be activated while the BS is otherwise powered off.

### CROSS-REFERENCE TO RELATED APPLICATIONS

This application is a continuation of International Patent Application No. PCT/CN2021/125474, filed Oct. 22, 2021, the contents of which are incorporated by reference herein its entirety.

### TECHNICAL FIELD

The application relates to wireless communications generally, and more specifically to methods and apparatus for power saving in mobile networks.

### BACKGROUND

Recommendation ITU-T L.1470 provides detailed trajectories of greenhouse gas (GHG) emissions for the global information and communication technology (ICT) sector compatible with the UNFCCC (United Nations Framework Convention on Climate Change) Paris agreement, and concludes the target of total CO₂ₑ emissions in Year 2015,2020,2025,2030 which are provided in Table 1 below.

TABLE 1
ICT sector trajectory with electricity
grid losses and supply included

| Total Co₂ₑ (Mt) | 2015 | 2020 | 2025 | 2030 |
|---|---|---|---|---|
| Mobile networks | 115 | 109 | 92 | 70 |
| Fixed networks | 67 | 59 | 42 | 27 |
| Data centres | 141 | 127 | 104 | 79 |
| User devices | 401 | 379 | 284 | 207 |
| Enterprise networks | 16 | 14 | 8 | 5 |
| Total include T&D | 740 | 687 | 530 | 388 |
| losses and fuel supply | | | | |

Assuming the total CO₂ₑ emissions in Year 2020 as baseline, the target of the total CO₂ₑ emissions in 2030 should be down to 70/109˜=64% for mobile networks, 27/59˜=46% for fixed network. However, with the continued dramatic rise of applications, services, devices and machines all being connected to the mobile and fixed network, the total Internet traffic in the next decade is expected to grow exponentially. One of the key challenges for next-generation networks is the ability to support the predicted traffic in a sustainable and economically viable way to meet the recommendation from the ITU and/or mandatory requirements on GHG emissions from each country. In addition to the resulting increased energy consumption due to increased traffic load, the rising energy costs, the environmental impact of networks, new environmental related laws in many countries, require that future communication networks be greener and more sustainable to meet the GHG emission target. Recognizing this challenge and the growing gap between traffic growth and network energy efficiency improvements, current semi-static mobile network architectures which employ partial muting of base stations (BSs) as needed cannot meet these challenging requirements at the same time.

### SUMMARY

A dynamic mobile network architecture is provided, with the objective of meeting greenhouse gas emission targets. The network adapts over time based on time varied traffic demand/load. This is achieved by providing two layers of base stations (BS). The top layer contains super BS that have larger coverage areas than the base stations of the second layer. Depending on traffic conditions, base stations of the second layer can be switched into a reduced power mode. Signaling procedures are provided for setting up connections between the BS of the second layer and the super BS, and for switching off and then activating previously switched off second layer BS. In some cases, the BS of the second layer has a lower power listening receiver to allow itself to be activated while the BS is otherwise powered off. A BS can be switched into a reduced power mode by switching off one or more serving cells of the BS.

According to one aspect of the present disclosure, there is provided a method in a first base station. The method involves transmitting a message to request setup of a connection between the first base station and a second base station, the message associated with at least one serving cell. The method continues with receiving a response indicating whether the request setup is accepted or not and transmitting a switch off request via the connection to the second base station. The switch off request is associated with at least a subset of the at least one serving cell.

In some embodiments, the message: includes an indication that the request setup is for an entire base station site (BSS) in which case the at least one serving cell includes all serving cells of the BSS; or includes an indication of all serving cells at an entire BSS in which case the at least one serving cell includes all serving cells of the BSS; or includes an indication that the request setup is for a specific radio access technology (RAT) in which case the at least one serving cell includes all serving cells of the specific RAT; or includes an indication that the request setup is for a specific RAT and a list of serving cells of the specific RAT in which case the at least one serving cell includes all serving cells on the list; or includes an indication of a list of serving cells in which case the at least one serving cell includes all serving cells on the list.

In some embodiments, when the message includes an indication that the request setup is for an entire base station site (BSS), the switch off request pertains to the entire BSS or to a specific RAT as indicated by a RAT indication in the switch off request; or when the message includes an indication of all serving cells at an entire BSS the switch off request pertains to all of the serving cells at the entire base station or to a specified subset of serving cells at the entire base station site, the specified subset indicated in the switch off request; or when the message includes an indication that the request setup is for a specific radio access technology (RAT) the switch off request pertains to all cells of the specific RAT; or when the message includes an indication that the request setup is for a specific RAT and a list of serving cells of the specific RAT the switch off request pertains to all cells of the specific RAT or to a specified subset of the list of serving cells of the specific RAT, the specified subset indicated in the switch off request; or when the message includes an indication of a list of serving cells the switch off request pertains to all serving cells on the list of serving cells, or to a specified subset of the list of serving cells, the specified subset indicated in the switch off request.

In some embodiments, the method further comprises: the first base station communicating data and/or signaling with at least one UE via a physical layer link when the first BS is powered on.

In some embodiments, the message includes public land mobile network (PLMN) information.

In some embodiments, the method further comprises: receiving a response to the switch off request indicating whether the switch off request is accepted or not; or in the absence of a response from the second base station to the switch off request before a timer having a specified duration expires, cancelling the switch off request by transmitting a switch off cancel to the second base station.

In some embodiments, the response to the switch off request includes at least one of the following: an indication of at least one PLMN; an indication of at least one radio access technology.

In some embodiments, the switch off request includes at least one of: an indication of a number of radio resource control (RRC) connected user equipments (UEs); an indication of total uplink traffic load; or an indication of total downlink traffic load.

In some embodiments, the switch off request includes the indication of the number of connected UEs per serving cell or per RAT level or for an entire base station site.

In some embodiments, the method further comprises: receiving an activation signal from the second base station.

In some embodiments, the activation signal includes at least one of: an indication of at least one serving cell to activate; an indication of at least one radio access technology; an indication of at least one PLMN.

In some embodiments, receiving the activation signal comprises receiving the activation signal using a low power receiver that is active while the base station is in the reduced power mode.

In some embodiments, receiving the activation signal comprises receiving a paging message.

In some embodiments, the method further comprises receiving activation related information from the second base station indicating at least one of: activation signal reception cycle time and time offset; deactivation duration or activation time.

In some embodiments, the method further comprises: transmitting a switch off notification to notify the second base station that the at least one serving cell to be switched off are switched off.

In some embodiments, the method further comprises: receiving a switch off notification from the second base station indicating that the at least one serving cell to be switched off can be switched off.

According to another aspect of the present disclosure, there is provided a method in a second base station. The method involves receiving a message to request setup of a connection between a first base station and the second base station. The message is associated with at least one serving cell. The method continues with transmitting a response indicating whether the request setup is accepted or not, and receiving a switch off request via the connection from the first base station. The switch off request is associated with at least a subset of said at least one serving cell.

In some embodiments, the message: includes an indication that the request setup is for an entire base station site (BSS) in which case the at least one serving cell includes all serving cells of the BSS; or includes an indication of all serving cells at an entire BSS in which case the at least one serving cell includes all serving cells of the BSS; or includes an indication that the request setup is for a specific radio access technology (RAT) in which case the at least one serving cell includes all serving cells of the specific RAT; or includes an indication that the request setup is for a specific RAT and a list of serving cells of the specific RAT in which case the at least one serving cell includes all serving cells on the list; or includes an indication of a list of serving cells in which case the at least one serving cell includes all serving cells on the list.

In some embodiments, when the message includes an indication that the request setup is for an entire base station site (BSS), the switch off request pertains to the entire BSS or to a specific RAT as indicated by a RAT indication in the switch off request; or when the message includes an indication of all serving cells at an entire BSS the switch off request pertains to all of the serving cells at the entire base station or to a specified subset of serving cells at the entire base station site, the specified subset indicated in the switch off request; or when the message includes an indication that the request setup is for a specific radio access technology (RAT) the switch off request pertains to all cells of the specific RAT; or when the message includes an indication that the request setup is for a specific RAT and a list of serving cells of the specific RAT the switch off request pertains to all cells of the specific RAT or to a specified subset of the list of serving cells of the specific RAT, the specified subset indicated in the switch off request; or when the message includes an indication of a list of serving cells the switch off request pertains to all serving cells on the list of serving cells, or to a specified subset of the list of serving cells, the specified subset indicated in the switch off request.

In some embodiments, the method further comprises: the second base station communicating data and/or signaling with at least one UE via a physical layer link when the first BS is powered off.

In some embodiments, the message includes public land mobile network (PLMN) information.

In some embodiments, the method further comprises: transmitting a response to the switch off request indicating whether the switch off request is accepted or not.

In some embodiments, the response to the switch off request includes at least one of the following: an indication of at least one PLMN; an indication of at least one radio access technology.

In some embodiments, the switch off request includes at least one of: an indication of a number of radio resource control (RRC) connected user equipments (UEs); an indication of total uplink traffic load; or an indication of total downlink traffic load.

In some embodiments, the switch off request includes the indication of the number of connected UEs per serving cell or per RAT level or for an entire base station site.

In some embodiments, the method further comprises: transmitting an activation signal to the first base station.

In some embodiments, the activation signal includes at least one of: an indication of at least one serving cell to activate; an indication of at least one radio access technology; an indication of at least one PLMN.

In some embodiments, receiving the activation signal comprises receiving a paging message.

In some embodiments, the method further comprises transmitting activation related information to the first base station indicating at least one of: activation signal reception cycle time and time offset; deactivation duration or activation time.

In some embodiments, the method further comprises: receiving a switch off notification from the first base station to notify the second base station that the at least one serving cell to be switched off are switched off.

In some embodiments, the method further comprises: transmitting a switch off notification to the first base station indicating that the at least one serving cell to be switched off can be switched off.

According to another aspect of the present disclosure, there is provided a base station comprising a processor and memory. The base station is configured to execute any of the methods summarized above, or described herein.

According to another aspect of the present disclosure, there is provided an apparatus comprising a processing unit. The processing unit is configured to execute any of the methods summarized above, or described herein.

According to another aspect of the present disclosure, there is provided a computer readable medium having computer executable instructions stored thereon that when executed by a base station cause the base station to execute any of the methods summarized above, or as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 shows an example of power consumption under different time and traffic load;

FIG. 6 is a schematic diagram of a network that includes a super base station to assist with network power saving;

FIG. 7 is a message flow diagram for a successful connection setup operation;

FIG. 8 is a message flow diagram for an unsuccessful connection setup operation;

FIG. 9 is a message flow diagram for a successful switch off operation;

FIG. 10 is a message flow diagram for an unsuccessful switch off operation;

FIG. 11 is a message flow diagram for an switch off cancel operation;

FIGS. 12 and 13 are message flow diagrams for switch off notification operations;

FIG. 14 is a schematic diagram of a base station including a low power listening receiver;

FIG. 15 shows an example of how UEs from different operators can be accommodated by a super BS;

FIG. 16 is a message flow diagram for a successful switch off indication operation; and

FIG. 17 is another message flow diagram for successful switch off indication operation.

### DETAILED DESCRIPTION OF ILLUSTRATIVE EMBODIMENTS

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

Current mobile networks are designed to accommodate peak hour traffic (i.e., wireless capacity) and employs a semi-static mobile network architecture in which BSs consume a similar amount of power in both peak hours and off. An example of power consumption versus load for current networks is depicted in FIG. 5, and it can be seen that the power consumption in current mobile networks do not generally follow the curve of traffic load/demand, and this is because of the semi-static mobile network architecture.

The BSs of a whole mobile network accounted for about 55% of the electricity charges of the whole mobile network from one operator. The power consumption of the whole mobile network is mainly increased proportionally with the number of active BS sites since the cooling system, e.g. an air conditioning system, and basic power supply system have to be powered on as long as there is an active BS working at the site even though there could be many BSs in one site. The cooling system and basic power supply system occupy around 45% in total. The power consumption from these two parts (cooling system and power supply) are relatively static compared with the time varying traffic load. Further, 90% of the power consumption of one BS (for example a gNB) is from the radio resource unit (RRU) which includes a power amplifier (PA) among other components. The power consumption of the PA varies a lot with the percentage of traffic load, for example 37% of the power consumption of the entire RRU part for a 30% load case. Thus, the number of BS sites and the number of PAs, which do not vary with the traffic load, will dominate the power consumption of the whole mobile network.

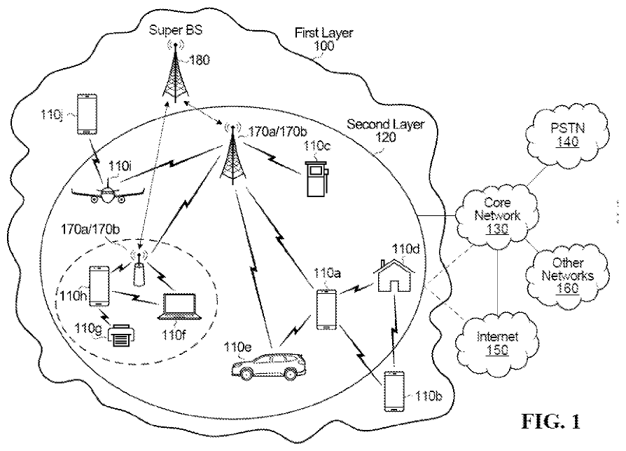

Referring to FIG. 1, as an illustrative example without limitation, a simplified schematic illustration of a communication system is provided. The communication system comprises first and second layers of base stations 100, 120 (more generally network nodes). The base stations of the second layer may, for example, be part of a next generation (e.g. sixth generation (6G) or later) radio access network, or a legacy (e.g. 5G, 4G, 3G or 2G) radio access network. The base stations of the first layer, also referred to herein below as super base stations, may also be part of a next generation access network. Other possibilities for the super BS are detailed below. One or more communication electric device (ED) 110a-110j (generically referred to as 110) may be interconnected to one another or connected to one or more network nodes (170a, 170b, generically referred to as 170) in the second layer of base stations 120. Some of the time, EDs may be connected to the first layer of base stations 100 as discussed in detail below. A core network 130 may be a part of the communication system and may be dependent or independent of the radio access technology used by base stations 100,120. Also, the communication system comprises a public switched telephone network (PSTN) 140, the internet 150, and other networks 160. The first layer contains super BS that have larger coverage areas than the base stations of the second layer. Depending on traffic conditions, base stations of the second layer can be switched into a reduced power mode. Signaling procedures are provided for setting up connections between the BS of the second layer and the super BS, and for switching off and then activating previously switched off second layer BS. In some cases, the BS of the second layer has a lower power listening receiver to allow itself to be activated while the BS is otherwise powered off. A BS can be switched into a reduced power mode by switching off one or more serving cells of the BS.

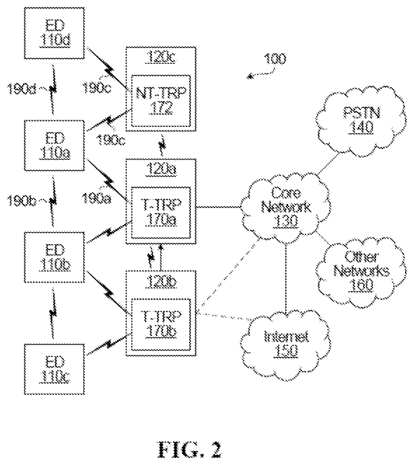

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

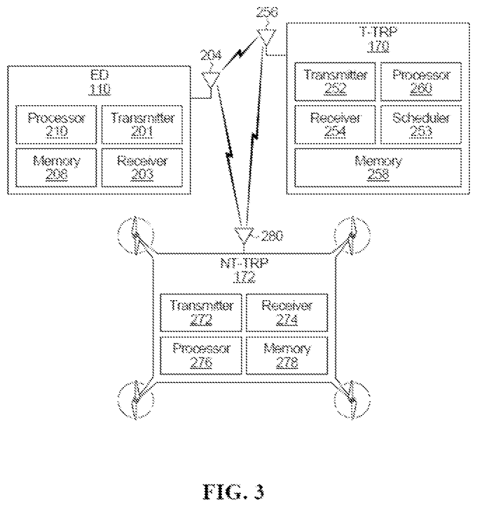

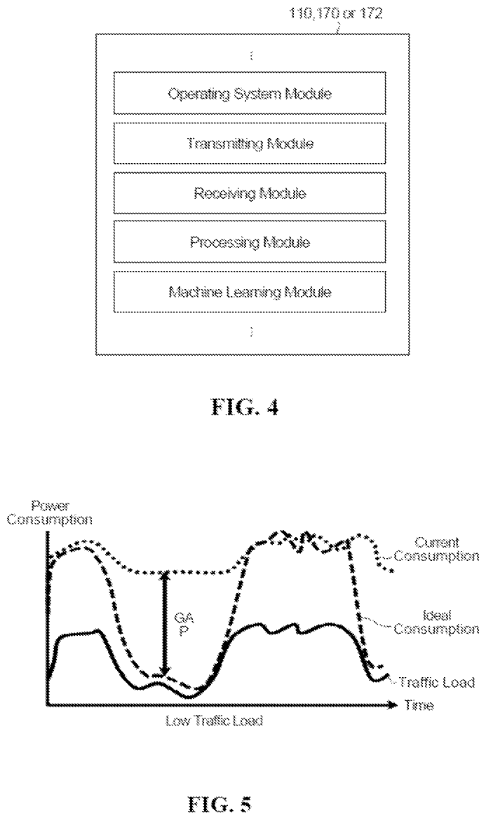

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

In accordance with an embodiment of the disclosure, a dynamic mobile network architecture is provided, with the objective of meeting the GHG emission targets; as detailed below, the network adapts over time to time varied traffic demand/load.

Taking FIG. 1 as an example, the provided network architecture includes a first layer of super BSs and second layer of BSs. The super BSs have large coverage areas compared to the other BSs, with the coverage area of one super BS of the first layer typically encompassing the coverage areas (or parts of coverage areas) of multiple BSs of the second layer. The BSs of the second layer provide both data and signaling functions for UEs while they are powered on, but they also have the capability to be switched into a low power mode of operation in which they do not provide data and signaling functions for UEs. In the description that follows, switching the BS to the lower power mode of operation can be referred to as switching off the BS, but there may be some low power reception capabilities that are maintained as detailed below; switching the BS to the lower power mode of operation can be referred to as switching off the BS, and this can include powering off the basic power supply and cooling system for the base station site when the BS is the only one active BS in the base station site. The super BSs of the first layer also provide both data and signaling functions for UEs, and in particular provide these functions while one or more base stations of the second layer are switched off. The super BS takes over providing data and signaling for the BSs that are switched off. The super BS that takes over data and signaling for a given BS may be static over time, for example, where the super BS has a fixed position, or in some designs of the super BS, can change over time, due to mobility of the super BS, for example, in a case where the super BS is satellite-based.

The second layer can be designed to accommodate peak hour traffic (i.e., wireless capacity); when there are few active UEs served by a BS site in off peak hours, the BS site can be completely powered off to save power. Meanwhile, the super BS will serve the UEs from the powered off sites in off peak hours. Therefore, the total number of BS sites that are powered on will decrease significantly with traffic load and save a lot of power.

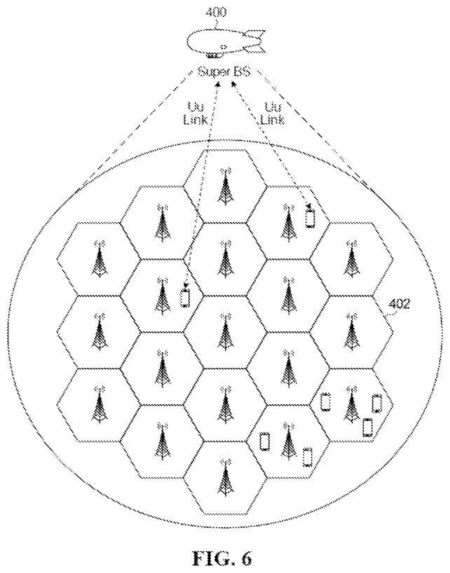

An example is shown in FIG. 6. Shown is a super BS 400 and a number of other BSs 402. The super BS has a larger coverage which can be several times larger than that of the other BSs 402. Correspondingly, multiple BSs are under the coverage of same super BS.

Various technologies may be used for the super BSs of the first layer. For example, a super BS, for an example, NT-TRP 172 in FIGS. 2 and 3, can be a satellite which may be low earth orbit (LEO), medium earth orbit (MEO), geosynchronous orbit (GEO), high earth orbit (HEO) or other types. A super BS may be a high altitude platform station (HAPS) which may be Loon, airship, solar-powered drone. Moreover, the super BS can also be high power high tower (HPHT) or medium power medium tower (MPMT).

The BSs of the second layer can be otherwise conventional cellular network BSs, for an example, T-TPR 170 in above FIGS. 1 to 3, but for the fact that they can be switched off, can hand their traffic to and from a super BS, and can participate in various signaling protocols to set up a connection with a super BS, and to switch on and off. A BSs can any type of base station; examples include a macro station, indoor/outdoor micro station, pico cell base station, remote radio head (RRH). Base stations are also sometimes referred to as radio access network (RAN) nodes.

A main characteristic of a super BS is that it can cover multiple BSs of the second layer.

A procedure to establish a connection between a BS of the second layer and a super BS is introduced. A BS needs to establish a connection with a super BS, so that when the BS expects to switch off itself, the corresponding request can be sent to the super BS. In some embodiments, in addition, or alternatively, the connection is provided so that a super BS can request the BS to switch itself off. The connection, once established, may be in the form of a logical communication channel between second layer BS and the super BS. Once the connection is setup, the BS and the super BS can communicate with each other over the connection; this connection may be used for switch off operations, as detailed below. In other words, if the connection is not setup, it may be assumed that no information is able to be exchanged between the second layer BS and super BS for the purpose of switch off operations.

Communication between a super BS and BS can be via a fixed network (such as a fiber based network) or via air interface. An air interface based method is preferred over a fiber based Xn interface, because an air interface based method can save the cost of setting up a point-to-point fiber based communication channel, and can save the power consumption of a point-to-point fiber based communication channel. In the detailed description that follows, it is assumed that the air interface based method is used, but it should be understood that fixed network connections can be used instead.

The air interface resources used for communication between BS and super BS are indicated by super BS. This may include, for example random access channel (RACH) resources, resources for connection establishment and control. Such information may be indicated by a super BS via system information block (SIB) message. A synchronization procedure including the exchange of synchronization information between the second layer of BS and super BS may be defined in a standard specification. In some embodiments, at least one signal from the synchronization procedure between the second layer of BS and the super BS is different from that used in a synchronization procedure between a UE and the second layer of BS. This different signal can be used to distinguish between the BS and a super BS; a super BS may be in charge of determining whether or not to switch off the second layer of BS/switch off specific BS forming part of the second layer. For example, the different signal can be a synchronization signal which is transmitted from the super BS in which case the second layer of BS can search the synchronization signal from the super BS and synchronize with the super BS in the time and frequency domain based on the searched synchronization signal.

For the air interface-based method, the BS may be synchronized with the super BS, before initiating the connection setup procedure.

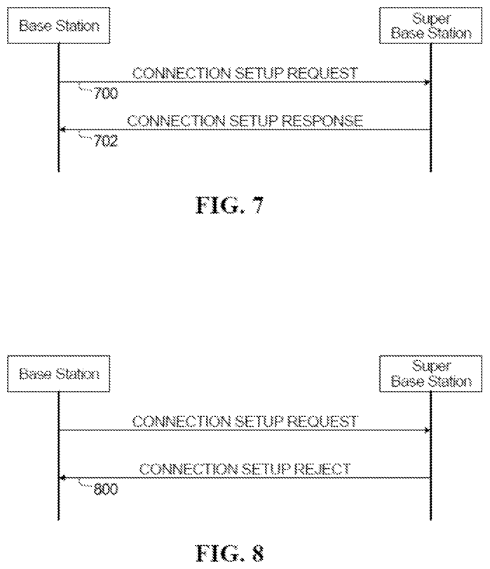

A message flow of a successful connection setup provided by an embodiment of the disclosure is shown in FIG. 7. The method with a BS initiating the procedure by transmitting a ‘connection setup request’ 700 to a super BS, which is preferably via air interface as indicated previously. The setup request is associated with at least one serving cell, in the sense that the connection, once established, can be used to switch off the associated serving cell(s). The associated serving cells may be explicitly indicated in the setup request, or a category of serving cell may be indicated in which case the setup request is associated with all serving cells of the indicated category.

An entire base station site can have one or three sectors, one sector can be a base station, the base station can be for a specific RAT, or a base station can support multiple RATs; one base station can support one or multiple serving cells, some serving cells of all serving cell supported by the base station can be active, while the other serving cells are inactive. Which serving cells or how many serving cells are active will depend on the traffic load. One base station may have one or multiple transmission reception points (TRPs).

In some embodiments, the setup request includes an indication that the setup request is for an entire base station site (BSS) in which case the at least one serving cell includes all serving cells of the BSS. Radio access technology (RAT) information may also be included indicating the RAT (for example 6G, NR, EUTRA) of the serving cells.

In some embodiments, the setup request includes an indication of all serving cells at an entire BSS in which case the at least one serving cell includes all serving cells of the BSS.

In some embodiments, the setup request includes an indication that the setup request is for a specific radio access technology (RAT) (for example 6G, NR, EUTRA). in which case the at least one serving cell includes all serving cells of the specific RAT.

In some embodiments, the setup request includes an indication that the setup request is for a specific RAT and a list of serving cells of the specific RAT in which case the at least one serving cell includes all serving cells on the list.

In some embodiments, the setup request includes an indication of a list of serving cells in which case the at least one serving cell includes all serving cells on the list. Radio access technology (RAT) information may also be included indicating the RAT of the serving cells on the list.

In some embodiments, public land mobile network (PLMN) information for each serving cell included on one of the lists of serving cells.

The method continues with, upon receipt of the connection setup request, the super BS determining whether this request can be accepted, and replying with a reply with ‘connection setup response’ at 702 if the request is accepted.

The message flow for the unsuccessful operation case as shown in FIG. 8. The BS initiates the procedure as described above with reference to FIG. 7. In this case, the super BS determines that the request cannot be accepted, the super BS will send ‘connection setup reject’ (or similar message) to BS at 800. The connection setup reject may include some assistance information, for example a reject cause value, the target super BS information with which the BS can again attempt to establish connection.

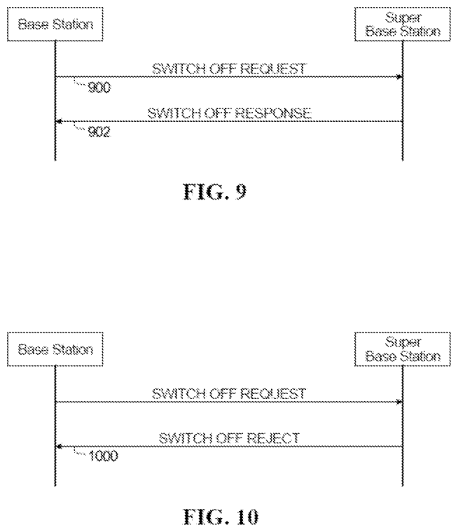

A message flow of a successful switch off operation provided by an embodiment of the disclosure is shown in FIG. 9. The purpose of the switch off procedure is to enable a BS to request a super BS to accommodate its served UEs, so that the base station node can be switched off.

For the successful operation case as shown in FIG. 9, the BS initiates the procedure by sending the switch off request to the Super BS at 900. In some embodiments, at least one of the following information is included in this message:
an indication of at least one PLMN;
an indication of at least one radio access technology.

In some embodiments, one or more of the following types of information is also included in the switch off request:
an indication of a number of radio resource control (RRC) connected UEs. This may, for example, be included at a per cell level, or at a per RAT level or for an entire base site level. The UEs can be from one operator or multiple operators, i.e. multiple PLMNs;
an indication of total uplink traffic load; or
an indication of total downlink traffic load.

The switch off request is associated with at least a subset of the serving cells associated with the setup request (and therefore also associated with the connection). Generally, the setup request is associated with at least one serving cell. The subset of serving cells with which the switch off request is associated may include one or more of the serving cells associated with the setup request. For example, when the setup request includes an indication that the setup request is for an entire base station site (BSS), the switch off request pertains to the entire BSS or to a specific RAT as indicated by a RAT indication in the switch off request.

When the setup request includes an indication of all serving cells at an entire BSS the switch off request pertains to all of the serving cells at the entire base station or to a specified subset of serving cells at the entire base station site, the specified subset indicated in the switch off request.

When the setup request includes an indication that the setup request is for a specific radio access technology (RAT) the switch off request pertains to all cells of the specific RAT.

When the setup request includes an indication that the setup request is for a specific RAT and a list of serving cells of the specific RAT the switch off request pertains to all cells of the specific RAT or to a specified subset of the list of serving cells of the specific RAT, the specified subset indicated in the switch off request.

When the setup request includes an indication of a list of serving cells the switch off request pertains to all serving cells on the list of serving cells, or to a specified subset of the list of serving cells, the specified subset indicated in the switch off request.

In some embodiments, based on some conditions, the second layer of BS will transmit a switch off request to the super BS with which the BS has set up a connection with. For example, these conditions can be that the time of day is off peak hour, or that total potential traffic load is no more than or less than a first threshold, or the total of active UEs serviced by the BS is no more than or less than a second threshold. The second layer of BS may transmit the switch off request. Each of these thresholds can be defined in a standard specification or informed by signaling from the super BS.

Upon receipt of a switch off request, the super BS determines whether this request can be accepted based on some information, that might, for example, include a number of active RRC connected UE serviced by this super BS and a number of active RRC connected UE serviced by the BS that sent the switch off request, the QOS requirements of the services provided by this requesting BS. In case the request is accepted, the super BS replies with switch off response at 902 indicating whether the switch off request is accepted or not. The switch off response may include at least one of the following:
an indication of at least one PLMN;
an indication of at least one radio access technology.

The switch off response can be used to switch off one or multiple serving cells, one or multiple sectors, a RAT, or an entire base station site. Furthermore, this indication can be for one operator or multiple operators. The switch off response may apply to all of the serving cells that the switch off request pertained to. Alternatively, the switch off response may indicate a specific list or category of serving cells (subset of the serving cells that the switch off request pertained to) for which the switch off request is accepted, in which case some serving cells can be switched off while others are not allowed to switch off.

A message flow for an unsuccessful switch off operation is shown in FIG. 10. The BS initiates the procedure by sending the switch off request to the super BS as described above with reference to FIG. 9. Upon receipt of this message, the super BS determines whether this request can be accepted as described previously. Upon determining the request cannot be accepted, a switch off reject 1000 is sent from the super BS to the BS.

In some embodiments, in the absence of a response from the super BS to the switch off request before a timer having a specified time duration, e.g. TXRELOFSO, expires in the BS, the BS cancels the switch off operation towards the Super BS by initiating a switch off cancel operation. A message flow for a switch off cancel operation is depicted in FIG. 11. Here, the BS transmits a switch off cancel at 1100, optionally including an appropriate cause value, e.g. TXRELOFSO expire. The duration of the timer TXRELOFSO may be related to the type of super BS, e.g. different values for the satellite, HAPS and terrestrial BS case.

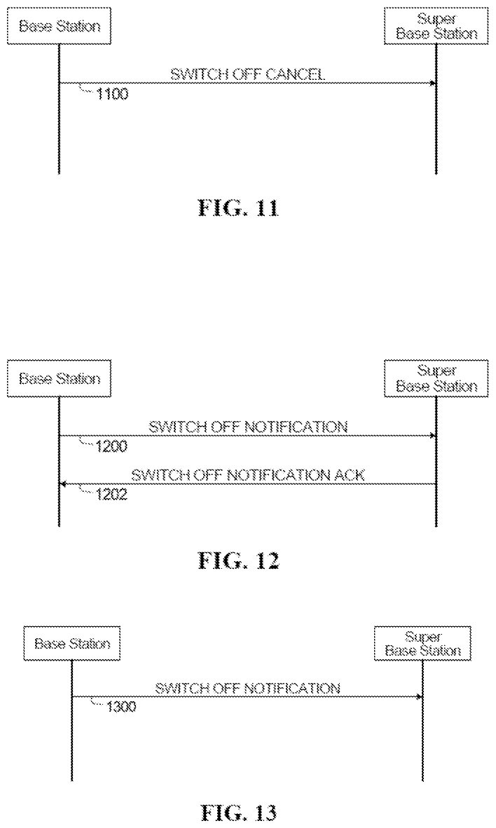

In some embodiments, the site/cells/RAT/sectors may not be switched off immediately after the aforementioned switch off procedure, therefore, a switch off notification procedure is also provided. A first example of a notification procedure is shown in FIG. 12. In this case, a BS initiates the procedure by sending the switch off notification at 1200 to notify the super BS that the site/cells/RAT/sectors to be switched off are switched off. The Super BS replies with a switch off notification acknowledgement (ACK) at 1202.

A second example of a notification procedure is shown in FIG. 13. In this case, a super BS initiates the procedure to indicate that the site/cells/RAT/sectors to be switched off can be switched off in BS by sending the switch off notification at 1300.

Once requested site/cells/RAT/sectors have been switched off, they will stay off until activated. Activation can take place on the basis of an activation signal from the super BS, or after some configured period of time. Information relating to the activation process for the BS can also be configured and indicated by the super BS. In some embodiments, an activation signal is only transmitted at specific times which may be configured to the BS such the BS need only listen for the activation signal at these specific times. In some embodiments, information related to the activation process is included in the switch off response of FIG. 9, or in the switch off notification ack of FIG. 12, or in the switch off notification of FIG. 13. The information related to activation may include at least one of the following information:
Activation signal reception cycle and time offset: based on these values, a BS can determine activation signal detection times, i.e. the frame number, the subframe number and optional slot number. The UE listens during these detection times for receipt of a possible activation signal
The deactivation duration or the activation time: the BS will be activated at the end of the deactivation duration or at the indicated activation time.

In some embodiments, the BS is implemented with a separate low power listening (LPL) receiver for receiving the activation signal. Advantageously, with the inclusion of such a receiver, the remainder of the BS can be powered down, while the separate receiver remains on, or is turned on according to an activation schedule.

In some embodiments, one LPL receiver is provided for a BS site, for example in one of the BS designated to communicate with the super BS, to receive the activation signal from the super BS when the BS site is powered off. The activation signal can, for example, be implemented as a pulse-on signal, a turn-on signal, wake-up signal.

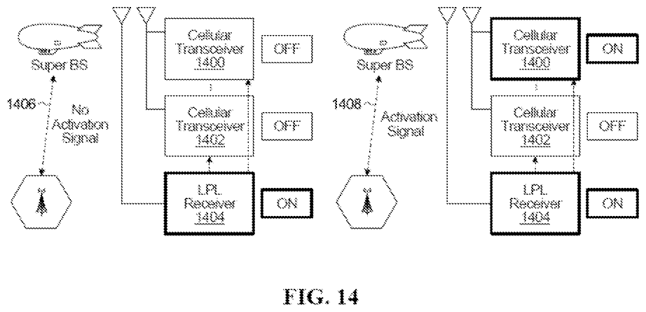

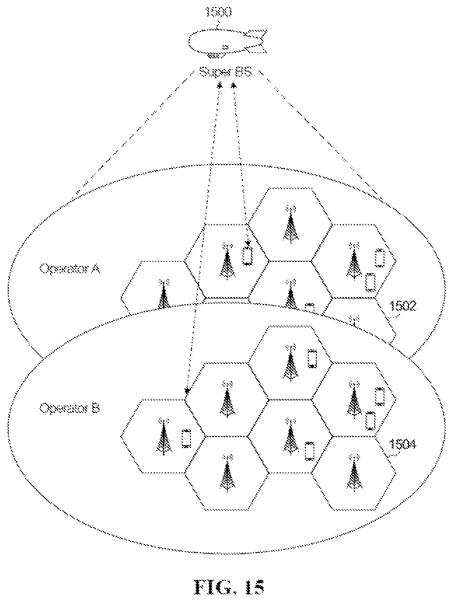

An example is shown in FIG. 14. Shown is a base station with two cellular transceiver modules 1400, 1402 and an LPL receiver 1404. Each cellular transceiver module corresponds with a serving cell, so powering up or down a serving cell corresponds with powering up or down the associated cellular transceiver module. As depicted in the left part of the Figure, the two cellular transceiver modules 1400, 1402 are off, as a result of a previous switch off procedure (not shown). At an activation time according to an activation schedule, there is no activation signal, as indicated at 1406. As shown in the right part of the Figure at a later time, at another activation time according to an activation schedule, there is an activation signal, as indicated at 1408. In this example, the activation signal is specific to cellular transceiver 1400, so that cellular transceiver is switched on, while cellular transceiver 1402 remains off.

The activation signal can be detected by the aforementioned low power listening receiver in the resources indicated by Super BS. Specifically, the activation signal can include the information to indicate which cell/sector/RAT need to be activated. This may include all or a specified subset of the previously switched off serving cells. When the BS receives the activation signal, the cellular transceiver module corresponding with the serving cells being activate will be activated/powered on. There activation signal may provide an implicit indication or an explicit indication of what to activate. In some embodiments, where aforementioned cell/sector/RAT is not indicated, or cannot be indicated, the whole base station site will be activated when the activation signal is received. In this case, an activation signal with a low power design, e.g. on off keying (OOK) can be used.

In some embodiments, a given super BS can serve UEs from a single mobile operator, or multiple different mobile operators.

For most regions, different operators have deployments. For the area covered by a super BS, can multiple BSs from different operators. An example is shown in FIG. 15, which shows a super BS 1500, and base stations 1502 for Operator A, and base stations 1504 for Operator B. Each operator has associated PLMN information.

In order for the super BS to serve US from multiple operators, multiple PLMN information is broadcast by super BS, to indicate which PLMNs the super BS can accommodate. PLMN information is included in the ‘connection setup request’ to identify PLMN of the requesting BS. Correspondingly, PLMN information can be explicitly/implicitly indicated by an activation signal to switch on the corresponding operator's serving cells.

With the provided embodiments, the power consumption of whole wireless network in the future can potentially meet the mandatory requirement on GHG emissions from each country while meeting the expected exponentially growth in traffic load at the same time, and also save on operating expenses of mobile operators.

In some embodiments, an enhanced paging message is used to activate the BS that has previously been switched off. With this embodiment, the super BS can transmit paging messages to UEs via a paging message and can transmit paging messages to BSs via an enhanced paging message. Separate configurations are employed and configured for a paging message as opposed to an enhanced paging message. These configurations may include at least one of the following:
separate message definition for paging and enhanced paging;
paging and enhanced paging are scrambled with different RNTI;
different configuration for paging and enhanced paging, e.g. search space, PCCH configuration, etc.

One or more BS sites can be indicated by an enhanced paging message. In some embodiments, cell/sector/RAT/site ID is included in the enhanced paging message

Compared with embodiments that include the low power receiver which is separated from cellular transceiver and specifically designed for receiving the activation signal, if a normal cellular transceiver is reused to receive the activation signal, this approach may consume more power than that the separated low power receiver does, but reusing existence cellular transceiver save cost and avoid complexity by introducing a separated low power receiver. In addition, if one BS at a BSS is designated to receive the activation signal, the remaining BS at the site can still be switched off.

In another embodiment, a switch off procedure is initiated by a super BS, in contrast to the approach described above with reference to FIG. 9, in which the switch off procedure is initiated by a BS.

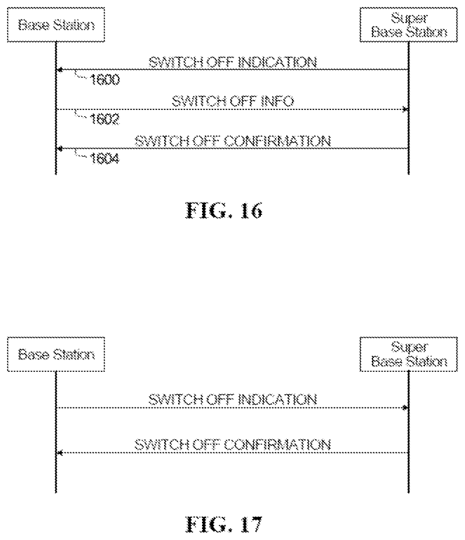

An example of this approach is shown in FIG. 16. The super BS initiates the procedure by sending the switch off indication 1600 to the BS to request deactivation. The same type of information used to identify the relevant serving cells that the switch off indication applies to may be included in the switch off indication as described previously for the switch off request.

Upon receipt of the indication message, the BS replies with a switch off info to the super BS at 1602. The switch off info may include the same type of information as described previously for the switch off request, such as number of RRC connected UEs, total uplink and/or downlink traffic volume etc.

Optionally, upon receipt of this message, the super BS replies with a switch off confirmation at 1604 to indicate that the switch off info was received.

Another approach is depicted in FIG. 17. This approach is the same as the approach of FIG. 16 except for the omission of the switch off info from the base station to the super BS.

Numerous modifications and variations of the present disclosure are possible in light of the above teachings. It is therefore to be understood that within the scope of the appended claims, the disclosure may be practiced otherwise than as specifically described herein.

What is claimed is:

1. A method in a first base station, the method comprising:
transmitting a message to request setup of a connection between the first base station and a second base station, the message associated with at least one serving cell;
receiving a response indicating whether the request of the setup is accepted or not; and
transmitting a switch off request via the connection to the second base station when a network load meets a condition to initiate power saving, the switch off request associated with at least a subset of the at least one serving cell.

2. The method of claim 1 wherein the message comprises:
an indication that the request of the setup is for an entire base station site (BSS), in which case the at least one serving cell includes all serving cells of the BSS; or
an indication of all serving cells at an entire BSS, in which case the at least one serving cell includes all serving cells of the BSS; or
an indication that the request of the setup is for a specific radio access technology (RAT), in which case the at least one serving cell includes all serving cells of the specific RAT; or
an indication that the request of the setup is for a specific RAT and a list of serving cells of the specific RAT, in which case the at least one serving cell includes all serving cells on the list; or
an indication of a list of serving cells, in which case the at least one serving cell includes all serving cells on the list.

3. The method of claim 1 wherein:
when the message comprises an indication that the request of the setup is for an entire base station site (BSS), the switch off request pertains to the entire BSS or to a specific radio access technology (RAT) as indicated by a RAT indication in the switch off request; or
when the message comprises an indication of all serving cells at an entire BSS, the switch off request pertains to all of the serving cells at the entire base station or to a specified subset of serving cells at the entire base station site, the specified subset indicated in the switch off request; or
when the message comprises an indication that the request of the setup is for a specific RAT, the switch off request pertains to all cells of the specific RAT; or
when the message comprises an indication that the request of the setup is for a specific RAT and a list of serving cells of the specific RAT, the switch off request pertains to all cells of the specific RAT or to a specified subset of the list of serving cells of the specific RAT, and the specified subset is indicated in the switch off request; or
when the message comprises an indication of a list of serving cells, the switch off request pertains to all serving cells on the list of serving cells, or to a specified subset of the list of serving cells, the specified subset indicated in the switch off request.

4. The method of claim 1, further comprising:
the first base station communicating data or signaling with at least one UE via a physical layer link when the first BS is powered on.

5. The method of claim 1 wherein the message comprises public land mobile network (PLMN) information.

6. The method of claim 1 further comprising:
receiving a response to the switch off request indicating whether the switch off request is accepted or not; or
in the absence of a response from the second base station to the switch off request before a timer having a specified duration expires, cancelling the switch off request by transmitting a switch off cancel to the second base station.

7. The method of claim 6 wherein the response to the switch off request includes at least one of the following:
an indication of at least one public land mobile network (PLMN); or
an indication of at least one radio access technology.

8. The method of claim 1 wherein the switch off request comprise at least one of:
an indication of a number of radio resource control (RRC) connected user equipments (UEs);
an indication of total uplink traffic load; or
an indication of total downlink traffic load.

9. The method of claim 8 wherein the switch off request includes the indication of the number of RRC connected UEs, and the indication of the number of RRC connected UEs is per serving cell or per radio access technology (RAT) level or for an entire base station site.

10. The method of claim 1 further comprising:
receiving an activation signal from the second base station.

11. The method of claim 10 wherein the activation signal includes at least one of:
an indication of at least one serving cell to activate;
an indication of at least one radio access technology; or
an indication of at least one public land mobile network (PLMN).

12. The method of claim 10 wherein receiving the activation signal comprises receiving the activation signal using a low power receiver that is active while the base station is in a reduced power mode.

13. The method of claim 10 wherein receiving the activation signal comprises receiving a paging message.

14. The method of claim 10 further comprising receiving activation related information from the second base station indicating at least one of:
activation signal reception cycle time and time offset; or
deactivation duration or activation time.

15. The method of claim 3 further comprising:
transmitting a switch off notification to notify the second base station that the at least one serving cell to be switched off are switched off.

16. The method of claim 3 further comprising:
receiving a switch off notification from the second base station indicating that the at least one serving cell to be switched off is allowed to be switched off.

17. A method in a second base station, the method comprising:
receiving a message to request setup of a connection between a first base station and the second base station, the message associated with at least one serving cell;
transmitting a response indicating whether the request of the setup is accepted or not; and
receiving a switch off request via the connection from the first base station when a network load meets a condition to initiate power saving, the switch off request associated with at least a subset of the at least one serving cell.

18. An apparatus comprising:
at least one processor; and
at least one non-transitory computer readable storage medium having instructions stored thereon which, when executed by the at least one processor, cause the apparatus to:
transmit a message to request setup of a connection between a first base station and a second base station, the message associated with at least one serving cell;
receive a response indicating whether the request of the setup is accepted or not; and
transmit a switch off request via the connection to the second base station when a network load meets a condition to initiate power saving, the switch off request associated with at least a subset of said at least one serving cell.

19. An apparatus comprising:
at least one processor; and
at least one non-transitory computer readable storage medium having instructions stored thereon which, when executed by the at least one processor, cause the apparatus to:
receive a message to request setup of a connection between a first base station and a second base station, the message associated with at least one serving cell;
transmit a response indicating whether the request of the setup is accepted or not; and
receive a switch off request via the connection from the first base station when a network load meets a condition to initiate power saving, the switch off request associated with at least a subset of the at least one serving cell.
